(19) United States
(12) Patent Application Publication
(10) Pub. No.: US 2010/0191585 A1
(43) Pub. Date: Jul. 29, 2010

(54) METERED RECHARGING SYSTEM

(75) Inventor: NATHANIEL T. SMITH, GATES MILLS, OH (US)

Correspondence Address: Gordon D. Kinder, 2231 Delamere Dr., Cleveland, OH, 44106, US

(73) Assignee: RECHARGE SYSTEMS LLC, GATES MILLS, OH (US)

(21) Appl. No.: 12/692,558

(22) Filed: Jan. 22, 2010

Related U.S. Application Data
(60) Provisional application No. 61/146,686, filed on Jan. 23, 2009.
(60) Provisional application No. 61/152,832, filed on Feb. 16, 2009.
(60) Provisional application No. 61/177,225, filed on May 11, 2009.

(51) Int. Cl. G06Q 50/00; G06F 17/00; G06K 5/00; H02J 7/00; G06Q 30/00; G06Q 20/00; G06Q 40/00; G06Q 10/00

(52) U.S. Cl. 705/13; 235/375; 235/380; 320/109; 700/236; 705/34; 705/40; 705/41; 705/412

(57) ABSTRACT

A parking management system generates a first record reflecting the time a parking interval begins. A persistent memory 12, 14 stores the first record. A recharging station 30 connects to a vehicle 40 having rechargeable batteries to supply electricity from a power source 60. A communications link 42 is connected with the recharging station 30 and communicates with the power source 60. A controller 50 enables the recharging station to direct electricity from the vehicle's batteries to the power source 60 in response to a request. A second device 32 generates a second record reflecting use of electricity for battery recharging and reflecting the repurchase of electricity directed from the vehicle's batteries. The persistent memory stores the second record. A third device reads the first and second records and calculates an amount due for parking and recharging and notifies the customer of the calculated amount.

### RELATED APPLICATIONS

This application claims the benefit of application No. 61/146,686, filed Jan. 23, 2009, application No. 61/152,832 filed Feb. 16, 2009, and application No. 61/177,225 filed May 11, 2009.

### FIELD OF THE DISCLOSURE

The present disclosure relates in general to the field of providing parking spaces with access to electricity for recharging vehicles with rechargeable batteries. Such a system may afford the owner of the vehicle the option of selling electricity back to the utility which provides the power to recharge the vehicle. A parking meter can also be incorporated into the system so that both parking and electricity can be sold by the same system.

### BACKGROUND

In many parking facilities, automated devices issue a printed ticket at an entry gate to the parking facility. The automated device generates an electronic record including the date and time of entry together with or as part of a unique identifying number. The record is encoded onto a magnetic stripe on the ticket or printed as a bar code on the ticket. Upon returning to the parking lot to remove the car, a user may pay the incurred fee either at an attended booth or at an automated pay station. With an automated pay station, the proper fee is determined when the pay station reads the record encoded on the ticket to compare the entry record with the time and date of exit. The automated pat station may then encode the stripe on the issued ticket as having been paid or the information may be transmitted electronically to a parking accounting system. If the automated pay station is located at the exit, payment will cause the exit gate to open automatically. Otherwise, the system allows a prescribed amount of time for the user to return to his vehicle and exit the lot. The user can exit the lot by presenting the validated ticket to an automated card reader associated with the exit gate. The ticket can then be collected by the exit gate, and the user is allowed to leave the lot. Alternatively, the user may present the ticket to an attendant who determines what the parking charges are and collects that fee from the person driving the car before the car is allowed to exit the lot.

Parking facilities where a user pre-pays for parking for a day or other pre-set time period are also known. Upon pre-paying, to a parking lot attendant or an automated system, a printed receipt may be issued bearing a record indicating the time purchased. This receipt or ticket serves as proof that a fee has indeed been paid.

With the price of gasoline vacillating wildly in the recent past and an increased emphasis on the environmental cost of powering vehicles with internal combustion engines, a new generation of electric vehicles is receiving large investments for accelerated market entry. Most major automobile manufacturers have announced plans to produce and mass market electric vehicles. These may be hybrid vehicles that include batteries for electric power storage as well as a small internal combustion engine. One such vehicle is the Toyota Prius. General Motors has announced that a plug-in hybrid electric vehicle (PHEV), called the “Volt”, will go into commercial production in 2010. Completely electric vehicles (EV's) are also being developed or have been developed by Ford, Daimler-Benz, Renault-Nissan, BMW, Honda, and about a dozen other companies.

To refuel a conventional liquid or gas powered vehicle takes only minutes. An electric vehicle, however, may take hours to recharge, depending on the battery-type and charger specification. In built up urban areas, such as cities and the like, vehicle owners may not have a defined private parking space with a power supply available. This is especially true in parking lots, garages, and on-street parking. While dedicated electric vehicle recharging bays are known, there is a need to have a conveniently located, regulated power supply available for recharging electric vehicles. A power supply which is located at the roadside or in a parking facility would be advantageous. Parking spaces located in parking lots or at the roadside with a power supply would allow an electric vehicle owner easy access to a power supply in order to recharge his or her vehicle while it is parked.

At the same time, it would not be economical to replace the widely used ticketing systems which employ paper tickets with a magnetic stripe or bar codes, such as are generated by many parking systems. Known parking systems mainly use paper tickets with one or more magnetic stripes or bar codes to record entry time and date so as to determine how much is owed by the vehicle owner upon exiting the parking lot. In addition, subscription and other frequent users are often issued cards that authorize access into and egress from gated parking garages or lots. It will be expensive enough to retrofit current parking structures, such as parking lots or garages, to sell electric power to vehicles without also having to replace the current payment infrastructure used in such facilities.

It would be advantageous to adapt the current payment infrastructure or ticketing and card systems also to sell power in parking areas. In that way, current ticketing and card systems would not need to be replaced when the parking systems are upgraded to provide battery recharging services.

### SUMMARY

The parking management system disclosed in this application includes a first device generating a first record reflecting the time a parking interval begins. A persistent memory stores the first record. The persistent memory may be either a part of a card issued to a customer upon entry to the parking facility or it may be stored in an accounting module and associated with a unique identifier which forms an account number for the transaction. A recharging station is connectable to a vehicle having rechargeable batteries to supply electricity from a power source to recharge the vehicle's batteries during a recharge cycle. A communications link is connected between the recharging station and the power source. The system includes a controller enabling the recharging station to direct electricity from the vehicle's batteries to the power source in response to a request from the power source received through the communications link to repurchase electricity. The recharging station has a second device generating a second record reflecting use of electricity for battery recharging and reflecting the repurchase of electricity directed from the vehicle's batteries. The second device writes the second record to the persistent memory. The system also includes a third device to read the first and second records and calculate an amount due for parking and recharging and to notify the customer of the calculated amount.

The persistent memory may be in magnetic or visible format and may be printed and/or encoded on a ticket issued to a customer on entry into a parking facility. The persistent memory may be part of a computer accounting system which stores the records for each transaction in an accounting module. The system may include vending machines which can create a record to be added to the persistent memory for items purchased at the vending machine. The vending machines may have card readers and encoders to do this, or they may communicate with an accounting module which in turn records the vending machine activity.

### DESCRIPTION OF FIGURES

FIG. 1 illustrates a parking system constructed following the teachings of the present disclosure.

FIG. 2 illustrates a second parking system constructed following the teachings of the present disclosure.

### DETAILED DESCRIPTION

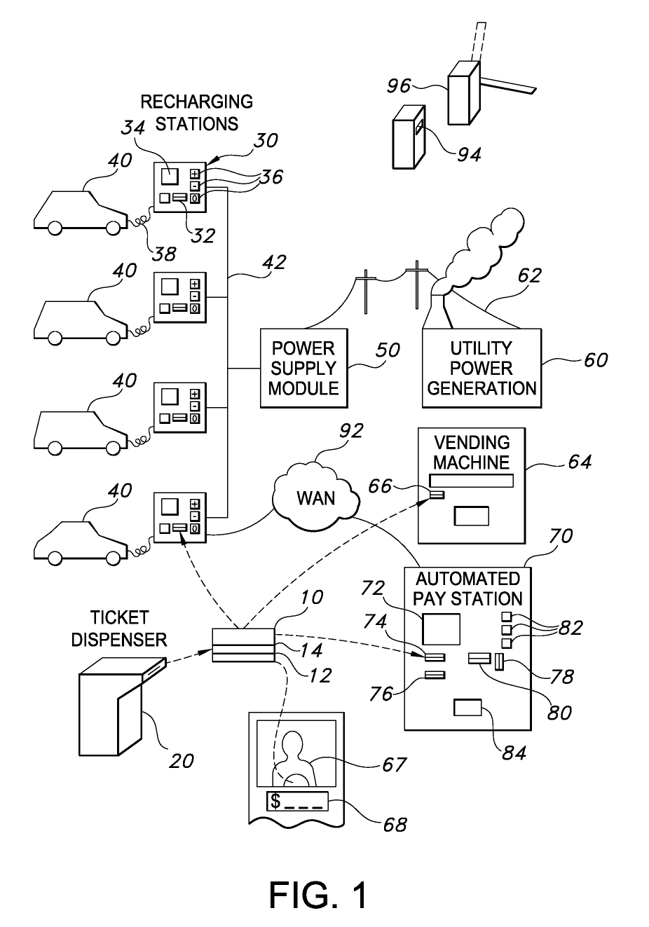

This application describes how to manage parking facilities and facilities for recharging vehicles with electric batteries and the associated equipment. A ticket 10 (FIG. 1) is issued upon entry to a parking facility. The ticket 10 includes a record unique to each ticket identifying it. Some or all of the parking spaces in the facility have recharging stations 30 where vehicles 40 with rechargeable batteries can park and have their batteries recharged. Such vehicles include electric vehicles (EV's) and plug-in hybrid electrical vehicles (PHEV's) or any other vehicle with rechargeable batteries.

Each station 30 provides for an electrical connection to the vehicle so that vehicles with rechargeable batteries can be recharged. Each recharging station 30 also has a device 32 that reads the ticket and generates a record of whether (and in some cases how much) electricity has been used to recharge the vehicle batteries. This record may be printed or encoded on the ticket. Upon exit, the ticket 10 is read by an attendant or machine, and parking and recharge costs are totaled and collected.

A ticket dispenser 20 is located at the entrance to a parking facility. The ticket dispenser 20 issues the ticket 10 which carries a first record unique to the ticket. That record may be generated by combining a number representing the day and time when and location where the ticket was issued. Other unique identifiers, such as a random number or any other unique number, may be used so long as each ticket has a distinguishable identifier. If the parking facility has only a single ticket dispenser 20, then the date and time of entry can serve as a unique identifier for the ticket. If there are several ticket dispensers, then each ticket issued has an indicium representing the dispenser that issued it so that each first record on each ticket is unique. This first record marks the beginning of a parking interval. The record may be encoded on one or more magnetic stripes 12 and 14 on the ticket 10. Alternatively, the first record may be printed on the ticket either in human readable characters, or as a barcode, or in any other manner so that the ticket functions as a persistent memory recording the time of the beginning of the parking interval.

As noted the parking facility is equipped with one or more recharging stations 30. The recharging stations 30 can be mounted as a stand-alone bollard or on posts (not shown) which can be located each next to a parking space, or they may be wall mounted (not shown). Each recharging station 30 provides electricity to be delivered to the vehicle 40 to recharge its batteries. To this end each recharging station 30 has a connection to a utility 60 which supplies electric power. While the utility 60 is illustrated as a conventional power plant or public utility connected to the recharging stations 30 through a conventional distribution network 62, the electric power for the recharging stations 30 could equally be supplied in whole or in part by a private utility or by renewable energy sources associated with the parking facility such as wind turbines and/or solar panels.

Each recharging station 30 makes it possible to connect with the vehicle 40 whose batteries are to be recharged. This connection can be effected by a cable 38 permanently connected to the recharging station 30. Alternatively, the recharging station 30 may have an electric outlet (not shown) into which the customer may plug his own cable. The recharging stations may enable more than one method of making the electrical connection between the recharging station 30 and the vehicle 40. The recharging stations 30 may also include a mechanism to secure either the electric outlet or to retract the cable 38 to prevent tampering when not in use. The electrical recharging stations 30 can supply electricity in different formats such as, for example, 110 VAC, 220 VAC, or 208 VAC. In addition, the recharging stations may be connected to a device which is inductively coupled to the batteries in the vehicle for use with vehicles that use inductive coupling to recharge their batteries.

Each recharging station 30 includes control circuitry which allows the customer to select the recharging cycle characteristics desired. For example, the customer may select a full recharge, in which case current will flow until the vehicle communicates that its batteries have been fully recharged or until the electric potential in the batteries reduces the recharging current flow to zero or a specified rate of current flow. A customer may also select a certain dollar amount as the recharge expense, the equivalent to putting a specified dollar's worth of gas in the gas tank. The customer may also select the amount of electricity measured in kilowatt hours or some fraction thereof. In addition, the customer may be able to select various properties of the recharging cycle such as a quick, high-voltage recharge or whether a slower low-voltage recharge cycle. If the vehicle is to be parked for an extended period of time, such as overnight, the driver can specify at what time the recharging should begin. This may be helpful in purchasing the lowest cost electricity. In addition, and as discussed more fully below, the customer may select to permit the electric utility 60 to repurchase electricity from the vehicle's batteries in the event that the utility encounters a surge in demand.

In order to affect these selections each recharging station includes a display 34 and a keypad key pad 36 connected to the control circuitry. Although a simple increment/decrement keypad is shown, any other may be used. For example, a touch screen could be used or a standard 12 button pad such as one finds on a touch tone telephone may be provided.

As illustrated in FIG. 1, the recharging station 30 encodes the ticket 10 with information about the recharging cycle preferences that have been selected. (In a subsequently described arrangement, rather than storing the recharging cycle preferences on the ticket, the recharging station can store that information on a networked memory.) As noted the ticket 10 has a first record for parking information. The ticket also has a second record for the recharging cycle information. To this end, the station 30 has a slot 32 into which the card 10 may be inserted. A device (not shown) within the recharging station 30 records the preferences and encodes the ticket 10 with the customer's selections. The encoding may be magnetic encoding, but alternatively or in addition, the device within the recharging station 30 may print the charging cycle information on the ticket 10 in a machine-readable form such as a barcode, or in a manner to be read by humans. The ticket 10 acts as a persistent memory for the electrical charging cycle preferences until the recharging cycle is terminated and the customer wants to settle his account for parking and recharging services. The recharging station 30, and particularly the control circuitry within, also maintains a record of the customers selections so that it can effect the customers requests as to the recharging requested.

The control panel 36 on the recharging station 30 can also be employed to authorize the repurchase of power from the battery or batteries in the electrically powered vehicle 40 to the provider of electricity (which may be electric utility 64), should the utility require same during a period of high load. During period of high electric load, the increased storage capacity provided by the batteries in electrically powered vehicles can provide benefits to the electric grid. These benefits include increased reliability and lower cost. Using vehicle batteries' stored potential can facilitate the large scale integration of intermittent renewable energy resources into the nation's energy infrastructure. It is believed that the value to the electric utility of tapping vehicle electric storage intermittently for power exceeds the cost of a two-way communication link between the vehicles and the electric grid and any reduction in vehicle battery life. The benefit to the vehicles' owners can be a credit or rebate from the provider of electricity or the electric utility 60 for the power withdrawn from the vehicle's batteries.

According to the present disclosure, the several recharging stations 30 can be connected by suitable electric conductors 42 to a power supply module 50. The power supply module 50 provides electric power from the grid 62 to multiple electric recharging stations 30. The conductors 42 provide a communication connection enabling the module 50 to poll each electric recharging station 30 when repurchases are requested by the electric utility 60. This can be accomplished by means of a modulated signal imposed on the electrical connection between the utility and the recharging stations or by a separate set of conductors used exclusively for communication. The conductors 42 also provide a path for electricity to each of the recharging station 30 and allow a drawdown of electricity from the batteries of the respective vehicles when power repurchases have been authorized and requested. The power supply module 50 can communicate with the utility 60 so that the utility can request to repurchase electricity stored in the batteries of vehicles 40. The communication can be by means of a high frequency modulated signal imposed on the grid 62 or a separate pathway can be provided such as separate communication conductors (not shown) or an Internet-based connection (not shown).

As an alternative, the power supply module 50 may be eliminated, and each of the recharging stations may be supplied with electric power directly from the grid 62. In this case each of the recharging stations 30 would communicate directly with the utility 60, either using a high frequency signal on the power supply lines or separate signal conductors. The communication between the supply module 50 and utility 60 can also be effected by any other known means such as using the internet, by radio, or any other know technique that allows the utility to request to repurchase electricity and

The ticket 10 is being used to accumulate charges to be paid at the end of the parking interval; other items may also be sold and the charges for them may also be accumulated on the ticket. To this end vending machines 64 may be located on the premises of the parking facility to sell various items that are traditionally sold in vending machines. For example, vending machines 64 could sell coffee, soft drinks, or snacks, umbrellas, or even the windshield wiper fluid or other automotive sundries. The vending machines have a device 66 for encoding the ticket 10 with a third record which represents the value of items purchased from the vending machine. (In a subsequently described arrangement, the third record can be saved on a networked memory instead of on the ticket 10.)

When the customer is ready to leave the parking facility, he returns to the vehicle 40, and inserts the ticket 10 into the slot 32 in the recharging station 30. The controller stops the recharging cycle if it is not complete and calculates the amount of electricity used. The device inside the recharging station then alters the second record on the ticket with information about the recharge cycle actually performed. This may be based on the number of kilowatt hours of electricity expended to recharge the vehicle batteries, but it could charge at different rates depending on whether a fast or slow charge was affected and/or depending upon the time of day. The second record will also reflect any credit for electricity purchased by the utility. Thus the second record encoded on the ticket reflects the value of the recharging cycle actually performed even if the customer comes back before the requested charging could be completed. Alternatively, the parking facility may charge a flat rate for access to the recharging capability regardless of the amount used.

After disconnecting the electrical cable 38 between the recharging station 30 in the vehicle 40, the customer drives his vehicle to the parking facility exit and hands the ticket 10 to an attendant 67. The attendant totals the amount owed for parking, recharging, and any vending items purchased. The attendant 67 also credits the customer for any electricity repurchased by the utility, and the amount owed is displayed on the display 68. The customer then settles the account. The attendant can do this totaling by hand if all of the information is printed in human readable characters on the ticket 10. Preferably, the information in the first, second, and third records will be in machine-readable form, and the attendant will have a ticket reader (not shown) which reads the encoded information and, together with associated software, generates a total based on that information.

In a variation of the exit procedure, the parking facility may use an automated pay station 70. The automated pay station 70 performs the same tasks as the attendant, only automatically. To this end, the automated pay station 70 includes a ticket reader 74 into which the customer may insert his ticket 10. The automatic pay station then reads the ticket 10 calculates the amount owed, displays the amount on display 72 to notify the customer of the calculated amount, and accepts payment.

Payment may be made by credit card, cash card, cash, or any other acceptable medium of exchange. The automated pay station 70 includes a display screen 72 as well as a keypad 82 for user input as well as a credit card reader 76. The automated pay station also includes a mechanism 78 for accepting coins and a mechanism 84 excepting bills, as well as a dispenser 84 for returning change owed to the customer.

In an alternative checkout procedure, a customer may report directly to an automated pay station 70 or attendant 67 and present his or her ticket 10. In this case, the second record will include an indication of which recharging station 30 is being used to recharge the customer's vehicle 40 and what recharge cycle preferences had been selected. When the ticket 10 is presented at the automated pay station prior to the customer returning to his vehicle, the automated pay station communicates with the recharging station 30 through a wide area network 92, terminating any ongoing battery recharging, and gathering the information required to complete the second record. The automated pay station 70 then calculates the amount owed, and collects the necessary amount. The automated pay station 70 then encodes the ticket 10 with an indication that the account has been paid in full. This action triggers a fixed time interval for the customer to leave the lot, presenting his ticket at a card reader 94 to open the gate 96 or to an attendant who similarly will open the gate allowing the vehicle to exit.

In a variation on this arrangement, in some parking facilities it may be desirable to have all parking and recharging services prepaid. In this event, a customer will park his vehicle at an available recharging station 30, make note of identification number for that station, and then walk to an automated pay station. At the automated pay station, the customer is issued a ticket encoded with the first record reflecting the amount of parking time the customer wishes to purchase and a second record reflecting the recharge cycle the customer wishes to purchase. Alternatively, the first and second records can be combined, especially where the recharging electricity is not metered but paid for at a flat rate. The ticket 10 can function as a receipt, especially if the information in the records is printed in human readable form. The customer then returns to his vehicle and makes the necessary electrical connections. Once the ticket 10 is read by the recharging station 30, recharging begins. The customer may be required to display the ticket on his dashboard. While such an arrangement may be particularly useful in municipal on-street parking, it could also have utility in parking lots and parking garages.

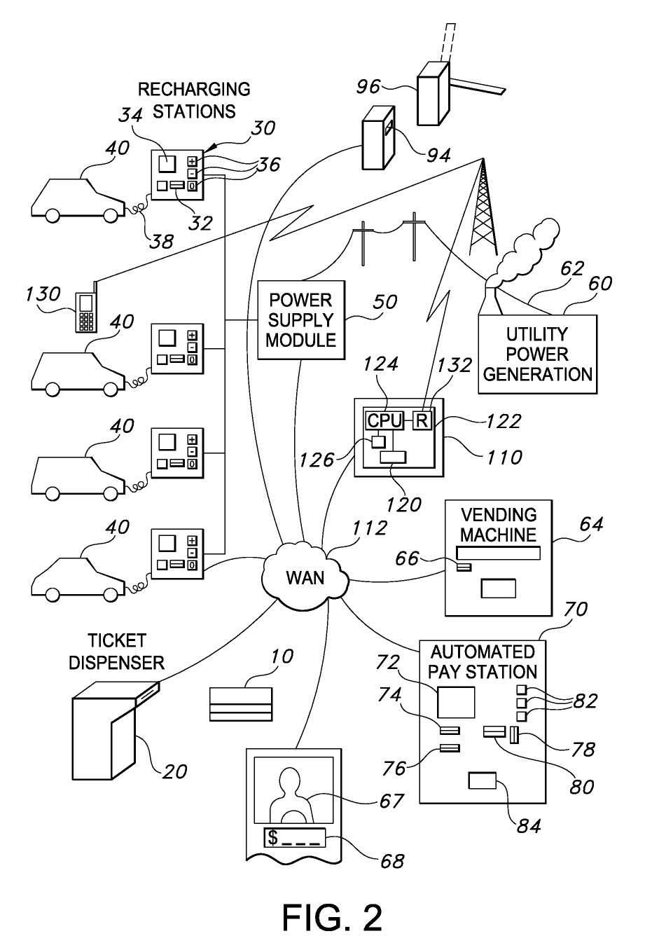

It is also contemplated that the parking and recharging services can be effectively managed using a ticket 10 which is encoded only with a unique identifying number. See FIG. 2. The first record (relating to the parking interval), the second record (relating to a recharge cycle), and the third record (relating to vending machine purchases), if any, are again kept in a persistent memory, but in this case the persistent memory is part of an accounting module 110 separate from the ticket 10. The accounting module 110 includes communication links 112 with the ticket dispenser 20, the recharging stations 30, the power supply module 50 (if included) and the automated pay station 70. Rather than encoding information in the various records directly on the ticket 10, each of these devices transmits the information it would have encoded on the ticket to the accounting module 110 where the information is stored in a persistent memory 120 in association with the data in the records with the unique identifier.

The accounting module 110 maintains a database with a record associated with each ticket 10. The first, second and third records (which are maintained in the FIG. 1 arrangement on the ticket 10) are kept each in one or more separate fields within each record in the database maintained by the accounting module 110. The database can be maintained in a computer system 122 which comprises a central processor 124 such as an Intel Pentium series processor or the equivalent. A main memory 126 is associated with the processor to facilitate the processor's execution of commands. The main memory 126 may be, for example, random access memory. A persistent memory 120 is also associated with the processor for storing data. The persistent memory 120 may include a hard disk drive, a tape drive, and optical drive, or a read-only memory, for example, or other similar sequential access storage device or devices which provides persistent storage of recorded information.

As noted, the accounting module 110 communicates with the various components of the system. The accounting module 110 communicates with the ticket dispenser 20 to assign a unique identifier to each ticket as it is dispensed. Alternatively, the ticket dispenser can generate the unique identifier and communicate it to the accounting module 110 as the ticket is dispensed so that the accounting module can assign it to a record in the database.

The accounting module 110 also is connected to each of the recharging stations 30 to record recharging preferences and whether electricity is dispensed in any recharge cycle. In some arrangements, the recharging station also records the amount of electricity dispensed and transmits that to the accounting module 110. For example, if a customer parks in a parking location equipped with a recharge station 30, but does not insert his ticket 10 into the recharging station to be read, then the power would not be turned on and no recharging would take place. If the ticket 10 is read by the recharging station 30, then the power is turned on and the accounting module is notified to record this fact in the record associated with the ticket's unique identifier.

The accounting module 110 further includes a connection with any vending machines 64 so that items purchased can be charged to the proper record in the database. The accounting module connection to the automated pay station 70 receives the unique identifier from the ticket inserted into the automated pay station card reader 74. The accounting module 110 then calculates the amount owed and transmits the amount owed for display on the display 72 of the automated pay station 70. That same communication link between the automated pay station 70 and the accounting module 110 may also be used to approve credit card payment authorizations.

In an additional variation, customers may use their cell phones to initiate a parking interval and authorize a recharging cycle. When using a cell phone 130, all of the records (the first, second, and third records) concerning any particular transaction are retained in the persistent memory 120 of the accounting module 110. To use the cell phone method, a driver finds an available recharging station and parks his car. He then calls a number which leads to a connection with a receiver 132 in the computer system 122. (Although shown as a radio receiver, the receiver 132 my be connected to a telephone exchange by a land line or a radio link or a combinations.) Over his cell phone, the customer can identify the specific charging station which will have a visible serial number on it and authorize payment from his cell phone account, which is confirmed by use of caller ID. Alternatively, customer can authorize payment to a credit card. Once his credit is approved, the customer may enter his recharging preferences. This can be done either through the cell phone 130 and an automated, aural menu, or at the recharging station. At this point the accounting module 110 creates a unique identifier or records the unique identifier that was generated by the dispenser 20 when the ticket was issued. The accounting module 110 records the entry time in its persistent memory 120. When the customer wishes to leave, he again calls the number connecting to the accounting module. The accounting module 110 then calculates all charges owed and confirms receipt either by charging the customer's cell phone account or a credit card account.

What is claimed is:

1. A parking management system comprising a first device generating a first record reflecting the time a parking interval begins,
a persistent memory storing the first record,
a recharging station connectable to a vehicle having rechargeable batteries to supply electricity from a power source to recharge the vehicle's batteries during a recharge cycle,
a communications link connected with the recharging station that can communicate with the power source and a controller enabling the recharging station to direct repurchased electricity from the vehicle's batteries to the power source in response to a request for such electricity from the power source received through the communications link, and
the recharging station having a second device generating a second record reflecting usage of electricity for a battery recharging cycle and reflecting the quantity, if any, of repurchased electricity directed from the vehicle's batteries, the second device writing the second record to the persistent memory, and
a third device for reading the first and second records and calculating an amount due for parking and recharging and for notifying the customer of the calculated amount.

2. The system of claim 1 wherein the first device dispenses a ticket to a customer and the persistent memory is encoded on the ticket.

3. The system of claim 2 wherein the persistent memory is a magnetic stripe on the ticket.

4. The system of claim 1 wherein the first device is a cell phone and the persistent memory maintains records in a location physically separate from the cell phone.

5. The system of claim 4 wherein the persistent memory is part of an accounting module which include a computer system.

6. The system of claim 1 wherein the persistent memory is bar code on the ticket.

7. A parking management system comprising:
a ticket dispenser that issues to a customer a ticket encoded with a unique identifier at the beginning of a parking interval and generates a record of the beginning of a parking interval;
a recharging station providing electricity to recharge the batteries of an electric vehicle, the recharging station reading the unique identifier encoded on the ticket and generating a record associated with the unique identifier and reflecting electricity used during a recharging cycle; and
a ticket reader associating the records generated by the ticket dispenser and the recharging station to determine the amount owed for parking and recharging.

8. The parking management system of claim 7 wherein ticket dispenser encodes the record of the beginning of the parking interval on the ticket.

9. The parking management system of claim 7 wherein the recharging station includes a communications link with a supplier of electricity and a controller enabling the recharging station to deliver electricity from the batteries of the electric vehicle to the supplier of electricity in response to a request for such electricity received through the communications link.

10. The parking management system of claim 7 further including a vending machine having a ticket reader, the vending machine reading the unique identifier and generating a record associated with the unique identifier and reflecting the value of merchandise purchased from the machine, the ticket reader associating the record generated by the vending machine with the records generated by the ticket dispenser and the recharging station to determine the amount owed by the customer for parking, recharging and vending.

11. The parking management system of claim 10 including an automated pay station, the automated pay station including a network connection for approving payment with credit, debit or smart cards.

10. The parking management system of claim 10 including an automated pay station, the automated pay station including an apparatus for accepting legal tender.

11. Parking management system of claim 10 wherein the automated pay station further includes a network connection for approving payment with credit or debit cards.

12. The parking management system of claim 9 wherein the recharging station includes an input device to enable a customer to specify in advance of receiving a request for electricity whether and to what extent electricity may be discharged from the batteries of the customer's vehicle in response to a request received through the communications link.
